(19) United States
(12) Patent Application Publication
(10) Pub. No.: US 2016/0018012 A1
(43) Pub. Date: Jan. 21, 2016

(54) CHECK VALVE HINGE PIN

(71) Applicant: Hamilton Sundstrand Corporation, Windsor Locks, CT (US)

(72) Inventors: Josh Kamp, Glastonbury, CT (US); Feng Feng, South Windsor, CT (US)

(21) Appl. No.: 14/331,975

(22) Filed: Jul. 15, 2014

(51) Int. Cl. F16K 15/03; E05D 5/12; E05D 5/10

(52) U.S. Cl. CPC F16K 15/035; E05D 5/10; E05D 5/128; E05D 2005/102

(57) ABSTRACT

One embodiment includes a hinge pin with a first end, a second end, and an interference portion located at or near the second end. A ratio of a length of the interference portion to an outer diameter of the interference portion ranges between approximately 0.3019 and 0.3341.

### BACKGROUND

The present embodiments relate to valves and, more particularly, to swing check valves.

A check valve is a type of valve that generally allows fluid to flow through the check valve in only one direction. A swing check valve utilizes at least one flapper or disc which rotates (i.e., pivots) about an axis between open and closed positions. In many swing check valves, the flapper is rotatably attached to a hinge pin which serves as the axis about which the flapper rotates between open and closed positions.

When in the closed position, the flapper sits on a housing of the check valve and blocks a flow of fluid through the check valve. When the flow of fluid into the check valve reaches a sufficient pressure (i.e. the cracking pressure), the flapper opens by rotating about the axis (e.g., the hinge pin). Swing check valves are generally designed for a specific cracking pressure depending on the application. When the fluid pressure drops below the cracking pressure and/or back pressure occurs, the flapper then rotates back to the closed position, preventing fluid from flowing back into the swing check valve.

### SUMMARY

One embodiment includes a hinge pin with a first end, a second end, and an interference portion located at or near the second end. A ratio of a length of the interference portion to an outer diameter of the interference portion ranges between approximately 0.3019 and 0.3341.

Another embodiment includes a method for installing a hinge pin in a valve. The method includes inserting a first end of the hinge pin into a first end of a housing of the valve, sliding the hinge pin into the housing until an interference portion at or near a second end of the hinge pin contacts the housing, and press fitting the interference portion of the hinge pin into the housing to create a clearance between an outer diameter of the hinge pin and a flapper coupling ranging between approximately 0.007 inch (0.018 cm) and 0.009 inch (0.023 cm).

### BRIEF DESCRIPTION OF THE DRAWINGS

FIG. 1 is a perspective view of a check valve.

FIG. 2A is a cross-sectional view of the check valve taken along line A-A of FIG.

1.

FIG. 2B is a close-up, cross-sectional view of a clearance between a hinge pin and a flapper coupling of FIG. 2A.

FIGS. 3A and 3B show the hinge pin of the check valve in perspective and elevational views, respectively.

While the above-identified drawing figures set forth one or more embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

Wear of a check valve hinge pin and cracking of check valve flappers constitute common modes of failure of a check valve. However, the present inventors have discovered that by optimally dimensioning a hinge pin of a check valve, a useful life of the hinge pin as well as the flappers can be extended, in turn extending the useful life of the check valve and reducing maintenance costs associated with the check valve.

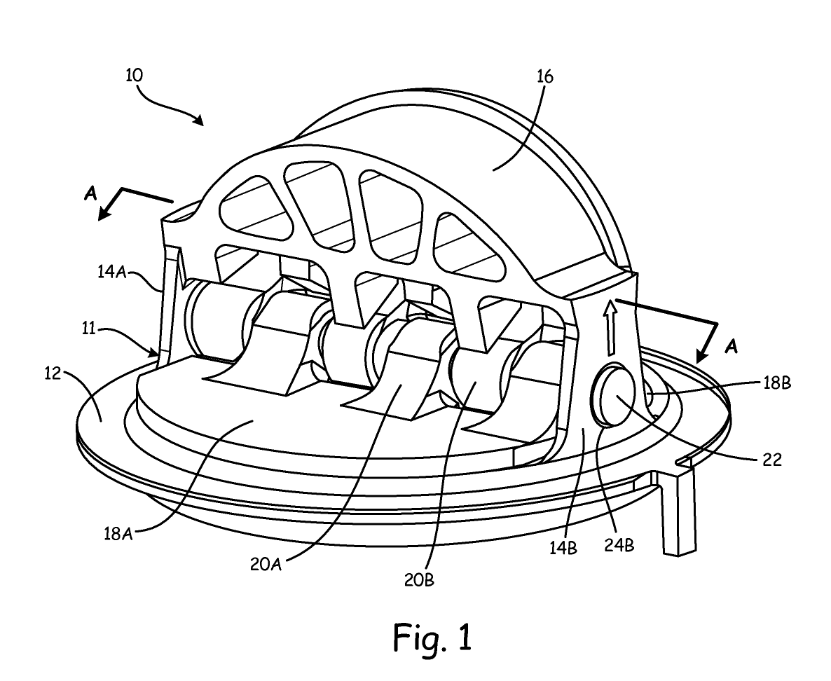

FIG. 1 is a perspective view of check valve 10. Body 11 of check valve 10 includes housing 12, posts 14A and 14B, and stop 16. Posts 14A and 14B can be formed integral with housing 12, such as by machining, or can be separate components attached to housing 12. Similarly, stop 16 can be formed integral with posts 14A and 14B or can be a separate component attached to posts 14A and/or 14B. Thus, body 11 can be a single integral component or can be made up of separate components housing 12, posts 14A and 14B, and stop 16.

When flappers 18A and 18B are in a closed position, as shown in FIG. 1, flappers 18A and 18B interface with housing 12 such that flappers 18A and 18B are seated on housing 12 and substantially block a flow of fluid through valve 10. Flapper couplings 20A rotatably connect flapper 18A to hinge pin 22, and flapper couplings 20B rotatably connect flapper 18B to hinge pin 22. Hinge pin 22 extends between posts 14A and 14B and can be made of any high temperature, high wear resistance material suitable for the particular operating environment of a specific valve 10 application. When a flow of fluid (e.g. various fluids including gaseous, liquid, and multiphase) reaches a sufficient pressure (i.e. the cracking pressure), flappers 18A and 18B are lifted off of housing 12 and rotate (i.e. pivot) about hinge pin 22 from the closed position to an open position, allowing fluid to pass through valve 10. Thus, the axis about which both flappers 18A and 18B rotate is defined by hinge pin 22. Flappers 18A and 18B rotate about hinge pin 22 until rotation of flappers 18A and 18B is impeded by stop 16.

Extensive cycling of flappers 18A and 18B between open and closed positions about hinge pin 22 results in significant wear on hinge pin 22. As such, hinge pin 22 is generally the first component of valve 10 to fail. Additionally, excessive cycling between open and closed positions can also cause flappers 18A and 18B to fail due to, for example, cracking.

However, the present inventors have discovered that wear on hinge pin 22 can be significantly reduced leading to a considerably longer useful life of hinge pin 22 by optimally dimensioning hinge pin 22. Furthermore, optimally dimensioning hinge pin 22 can also prolong a useful life of flappers 18A and 18B.

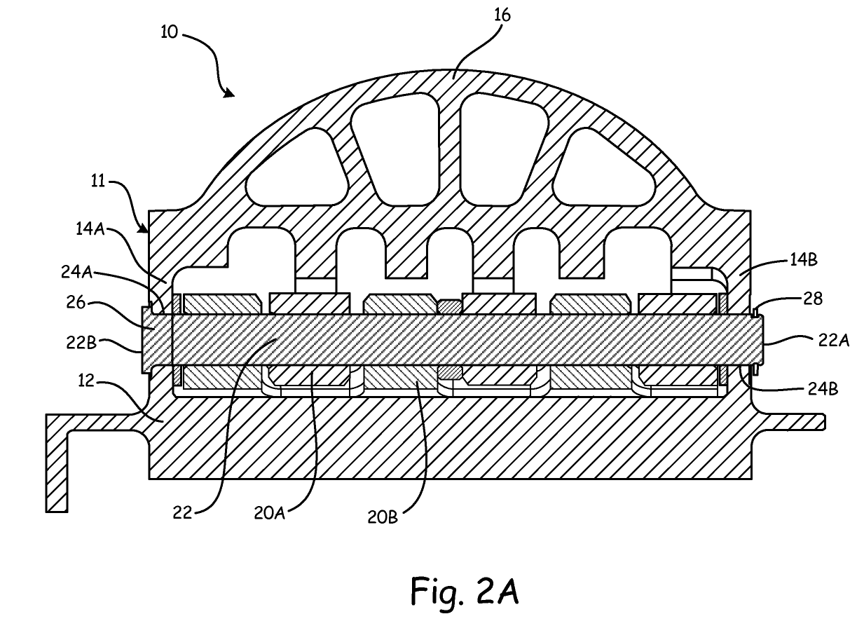

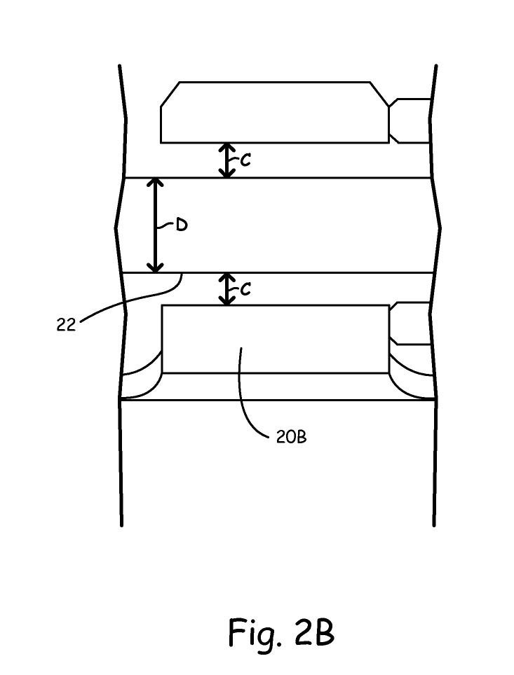

FIG. 2A shows a cross-sectional view of valve 10 of FIG. 1 taken along line A-A. Hinge pin 22 can be installed in valve 10 by inserting first end 22A of hinge pin 22 into opening 24A (i.e. a hole in post 14A) on an end of body 11. Hinge pin 22 can then be slid into body 11, such that hinge pin 22 slides through each of the flapper couplings 20A and 20B. Hinge pin 22 can be slid into body 11 until interference portion 26 at or near second end 22B of hinge pin 22 contacts body 11, for example at opening 24A. Interference portion 26 is generally of a diameter such that hinge pin 22 is no longer easily slidable within body 11 (e.g. a diameter of interference portion 26 is as large as or larger than a diameter of opening 24A). As such, hinge pin 22 can be further slid into body 11 by, for example, press fitting interference portion 26 into body 11. Once interference portion 26 is slid into body 11, first end 22A of hinge pin 22 is generally made to protrude at least partially out from body 11 at opening 24B (i.e. a hole in post 14B). In the illustrated embodiment, snap ring 28 can be attached on first end 22A of hinge pin 22 which protrudes at least partially out from body 11.

In another embodiment, it can be beneficial to cool hinge pin 22 before installing hinge pin 22 in valve 10. Cooling hinge pin 22 causes hinge pin 22 to shrink (i.e. hinge pin 22 has a smaller outer diameter as compared to an uncooled hinge pin 22), which can allow hinge pin 22 to be more easily inserted into opening 24A of body 11 and slid into body 11. In a further embodiment, it can be beneficial to heat body 11 before installing hinge pin 22 in valve 10. Heating body 11 causes body 11 to expand (e.g., openings 24A and 24B have larger diameters as compared to holes 24A and 24B of an unheated body 11), which can allow hinge pin 22 to be more easily inserted into opening 24A of body 11 and slid into body 11. In yet another embodiment, both hinge pin 22 can be cooled and body 11 can be heated.

To remove hinge pin 22 from body 11, a support means can be attached to body 11 to hold body 11 stationary. The support means can be any means that substantially prevents movement of body 11 without deforming body 11. Then, once body 11 is held stationary, hinge pin 22 can be pushed out from body 11. It is generally easiest to push hinge pin 22 out from body 11 by pushing hinge pin 22 in a direction such that second end 22B (i.e. at or near where interference portion 26 is located) is the first end to slide out from body 11.

Referring to FIG. 2B, a close-up, cross-sectional view of hinge pin 22 slid within flapper coupling 20B is shown. Installing hinge pin 22 into body 11 of valve 10 can create clearance C between outer diameter D of hinge pin 22 and flapper coupling 20B. Furthermore, clearance C can be the same between outer diameter D and each flapper coupling 20A or 20B, such that a substantially uniform clearance C is created between outer diameter D and all flapper couplings 20A and 20B.

By optimally dimensioning hinge pin 22 (described below) and installing hinge pin 22 in body 11, clearance C is created to range between approximately 0.007 inch (0.018 cm) and 0.009 inch (0.023 cm). Clearance C within this range strikes a balance between reducing stresses in hinge pin 22 and flappers 18A and 18B, and allowing valve 10 to meet leakage requirements. If clearance C is smaller than the described range, then flappers 18A and 18B will not seat properly on housing 12 under all tolerance conditions. In certain applications, when flappers 18A and 18B are in the closed position valve 10 can be required to block a specified percentage of fluid from passing through valve 10; this is commonly referred to as a leakage requirement of valve 10. If flappers 18A and 18B do not seat properly on housing 12, fluid cannot be completely blocked from passing through valve 10, and as a result undesired leakage through valve 10 ensues and valve 10 can be prohibited from meeting leakage requirements of a particular application. In addition to valve 10 potentially failing to meet a leakage requirement, when flappers 18A and 18B do not seat properly on housing 12, flappers 18A and 18B, as well as hinge pin 22, wear unevenly causing flappers 18A and 18A and hinge pin 22 to fail after a lower number of cycles than designed.

On the other hand, if clearance C is larger than the described range too much room for movement of flappers 18A and 18B relative hinge pin 22 is provided creating an unacceptably high reaction force between flappers 18A and 18B and hinge pin 22. This reaction force then induces stresses in flappers 18A and 18B and hinge pin 22 which results in wear and ultimately premature failure of flappers 18A and 18B and hinge pin 22. Due to the detrimental effects of a high reaction force, if there was no need to meet a leakage requirement then clearance C would be designed to be as small as possible. However, creating clearance C to range between approximately 0.007 inch (0.018 cm) and 0.009 inch (0.023 cm) reduces the reaction force to a level at which stresses in hinge pin 22 and flappers 18A and 18B substantially do not cause premature failure of hinge pin 22 and flapper 18A and 18B, while still ensuring valve 10 meets leakage requirements.

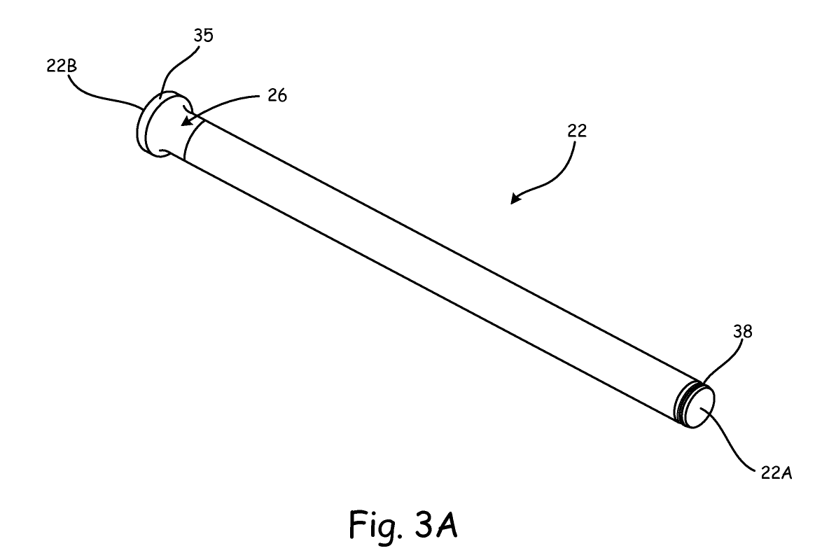

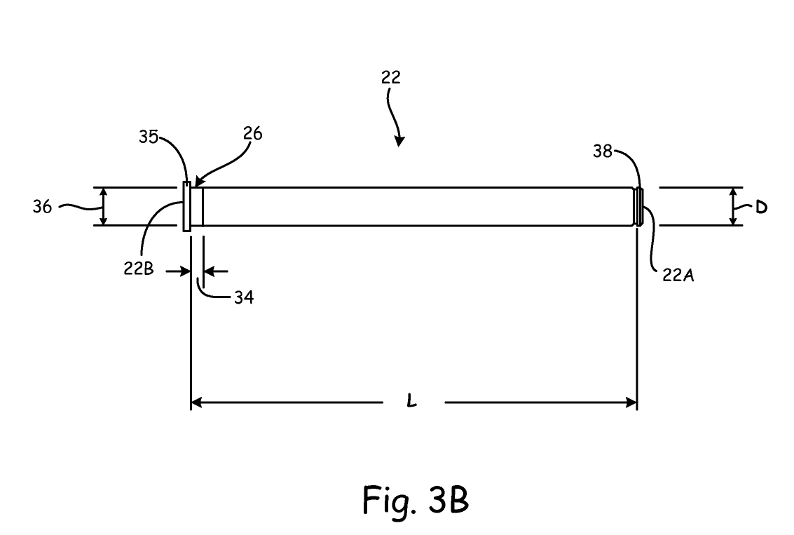

FIGS. 3A and 3B show hinge pin 22. FIG. 3A is a perspective view of hinge pin 22, while FIG. 3B is a side elevational view of hinge pin 22. Hinge pin 22 can be optimally dimensioned so as to prolong a useful life of hinge pin 22 as well as flappers 18A and 18B.

Hinge pin 22 has outer diameter D. Outer diameter D extends substantially uniformly axially along and circumferentially around hinge pin 22 from end 22A to a beginning of interference portion 26. Outer diameter D can range between approximately 0.3115 inch (0.7912 cm) and 0.3125 inch (0.7938 cm). In the illustrated embodiment, hinge pin 22 outer diameter D is approximately 0.3120 inch (0.7925 cm). In other embodiments, hinge pin 22 can include a plating or coating layer (not shown) axially along and circumferentially around all or part of hinge pin 22. Any material that is capable of withstanding high operating temperatures can be used, such that the coating has a high hardness at the operating temperature. Where a coating layer is included on hinge pin 22, outer diameter D (as well as all other dimensions of hinge pin 22) still remains within the same described range. Thus, for example, where a coating layer is to be used on hinge pin 22, an outer diameter of hinge pin 22 without the coating can be selected so that an outer diameter of hinge pin 22 with a coating layer is within the described range.

Hinge pin 22 also has length L. Length L is a length of hinge pin 22 that is within body 11. Length L includes portions of hinge pin 22 that are within openings 24A and 24B (i.e. length L only does not include portions of hinge pin 22 that protrude out from openings 24A and 24B (i.e. retention groove 38 which protrudes out from opening 24B and pin head 35 which protrudes out from opening 24A)). Length L can range between approximately 3.70 inch (9.40 cm) and 3.71 inch (9.42 cm). In the illustrated embodiment, length L is approximately 3.705 inch (9.411 cm).

By dimensioning hinge pin 22 outer diameter D and length L to be within the described ranges, an optimal ratio of length L to outer diameter D, 11.8400-11.9101, is achieved and a useful life of hinge pin 22 and flappers 18A and 18B can be extended. If a ratio of length L to outer diameter D is larger than the optimal ratio, hinge pin 22 can fail because a load created upon impact of flappers 18A and 18B (via couplings 20A and 20B) with hinge pin 22 during rotation of flappers 18A and 18B is reacted solely by hinge pin 22 causing hinge pin 22 to excessively deflect (i.e. bend) every time flappers 18A and 18B rotate. This can lead to hinge pin 22 failure, for example, due to wear. Conversely, if a ratio of length L to outer diameter D is smaller than the optimal ratio, flappers 18A and 18B can fail because a load created upon impact of flappers 18A and 18B (via couplings 20A and 20B) with hinge pin 22 during rotation of flappers 18A and 18B is reacted solely by flappers 18A and 18B causing flappers 18A and 18B to be imparted with excessive stress levels every time flappers 18A and 18B rotate. This can lead to failure of flappers 18A and 18B, for example, due to cracking.

Hinge pin 22 also has interference portion 26 at or near end 22B. Interference portion 26 extends substantially uniformly axially along and circumferentially around hinge pin 22 from a beginning of interference portion 26 to an interface with pin head 35. Pin head 35 can have a length, for example, ranging between approximately 0.055 inch (0.140 cm) and 0.065 inch (0.165 cm), and in the illustrated embodiment pin head 35 has a length of approximately 0.060 inch (0.152 cm). Interference portion 26 has length 34 which can range between approximately 0.095 inch (0.241 cm) and 0.105 inch (0.267 cm). In the illustrated embodiment, length 34 of interference portion 26 is approximately 0.100 inch (0.254 cm). Interference portion 26 also has outer diameter 36 which can range between approximately 0.3143 inch (0.7983 cm) and 0.3147 (0.7993 cm). In the illustrated embodiment, outer diameter 36 is approximately 0.3145 inch (0.7988 cm).

By dimensioning hinge pin 22 interference portion 26 length 34 and outer diameter 36 to be within the described ranges, an optimal ratio of length 34 to outer diameter 36, 0.3019-0.3341, is achieved which retains hinge pin 22 within body 11 during peak impact forces. If a ratio of length 34 to outer diameter 36 is larger or smaller than the optimal ratio, hinge pin 22 can fail to be retained within body 11, at least during peak impact forces. This can result because either length 34 is not long enough for the outer diameter 36 used, or outer diameter 36 is not wide enough for the length 34 used, resulting in interference portion 26 failing to generate sufficient hinge pin retention force within opening 24A. In other words, an interference fit between hinge pin 22 at end 22B and opening 24A must be designed to create sufficient retention force such that hinge pin 22 is retained within body 11 during a range of possible impact forces, including maximum impact forces. Impact forces can result from flappers 14A and/or 14B rotating to the open position, colliding with stop 16, and consequently transferring a load resulting from this contact to hinge pin 22 through couplings 20A and 20B. Impact forces can cause hinge pin 22 to flex (i.e. bend). Using a minimum optimal interference fit between end 22B and opening 24A (i.e. ratio of length 34 to outer diameter 36 of 0.3019) allows hinge pin 22 to withstand impact forces of 1150 lbf (5115 N). Using a maximum optimal interference fit between end 22B and opening 24A (i.e. ratio of length 34 to outer diameter 36 of 0.3341) allows hinge pin 22 to withstand impact forces of 3450 lbf (15,346 N). At the same time, using any interference fit within the optimal ratio provides sufficient support to hinge pin 22 such that hinge pin 22 does not overly flex during high speed impact with flapper couplings 20A and 20B. In sum, the retention force created through use of the optimal ratio of length 34 to outer diameter 36 must be greater than the impact forces on hinge pin 22 (i.e. forces causing hinge pin 22 to bend, created when flapper couplings 20A and 20B impact hinge pin 22.) Consequently, preventing excessive bending of hinge pin 22 through use of the optimal ratio of length 34 to outer diameter 36 inhibits wear of hinge pin 22 and in turn prolongs a useful life of hinge pin 22.

In one embodiment, snap ring 28 can be attached to hinge pin 22 at retention groove 38 on first end 22A of hinge pin 22. Retention groove 38 can have a length ranging between approximately 0.025 inch (0.064 cm) and 0.035 inch (0.089 cm), and in the illustrated embodiment retention groove 38 has a length of approximately 0.030 inch (0.076 cm). Although, any length of retention groove 38 that is sufficient for attaching snap ring 28 can be used. Snap ring 28 provides backup or emergency retention of hinge pin 22 within body 11 in the event interference portion 26 solely fails to retain hinge pin 22 within body 11.

### DISCUSSION OF POSSIBLE EMBODIMENTS

The following are non-exclusive descriptions of possible embodiments of the present invention.

A hinge pin comprising a first end; a second end; and an interference portion located at or near the second end, wherein a ratio of a length of the interface portion to an outer diameter of the interface portion ranges between approximately 0.3019 and 0.3341.

The hinge pin of the preceding paragraph can optionally include, additionally and/or alternatively, any one or more of the following features, configurations and/or additional components:

The length of the interface portion ranges between approximately 0.095 inch (0.241 cm) and 0.105 inch (0.267 cm) and the outer diameter of the interface portion ranges between approximately 0.3143 inch (0.7983 cm) and 0.3147 inch (0.7993 cm).

The length of the interface portion is approximately 0.100 inch (0.254 cm) and the outer diameter of the interface portion is approximately 0.3145 inch (0.7988 cm).

An outer diameter of the hinge pin from the first end to a beginning of the interference portion ranges between approximately 0.3115 inch (0.7912 cm) and 0.3125 inch (0.7938 cm).

The outer diameter of the hinge pin from the first end to the beginning of the interference portion is approximately 0.3120 inch (0.7925 cm).

The hinge pin is configured to be placed in a housing of a valve, and wherein a length of the hinge pin configured to be located within the housing of the valve ranges between approximately 3.70 inch (9.40 cm) and 3.71 inch (9.42 cm).

The length of the hinge pin configured to be located within the housing of the valve is approximately 3.705 inch (9.411 cm).

A retention groove at or near the first end of the hinge pin.

A method for installing a hinge pin in a valve, the method comprising inserting a first end of the hinge pin into a first end of a housing of the valve; sliding the hinge pin into the housing until an interference portion at or near a second end of the hinge pin contacts the housing; and press fitting the interference portion of the hinge pin into the housing to create a clearance between an outer diameter of the hinge pin and a flapper coupling ranging between approximately 0.007 inch (0.018 cm) and 0.009 inch (0.023 cm).

The method of the preceding paragraph can optionally include, additionally and/or alternatively, the following techniques, steps, features and/or configurations:

Sliding the hinge pin into the housing comprises sliding the hinge pin through each flapper coupling.

Creating a clearance between an outer diameter of the hinge pin and each flapper coupling ranging between approximately 0.007 inch (0.018 cm) and 0.009 inch (0.023 cm).

Positioning the first end of the hinge pin to protrude out from a second end of the housing of the valve.

Attaching a snap ring to a retention groove on the first end of the hinge pin.

Cooling the hinge pin such that hinge pin shrinks and is insertable into the first end of the housing of the valve.

Heating the housing of the valve such that the housing expands for inserting the hinge pin into the first end of the housing.

Any relative terms or terms of degree used herein, such as “generally”, “substantially”, “approximately”, and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, temporary alignment or shape variations induced by operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A hinge pin comprising:
a first end;
a second end; and
an interference portion located at or near the second end, wherein a ratio of a length of the interface portion to an outer diameter of the interface portion ranges between approximately 0.3019 and 0.3341.

2. The hinge pin of claim 1, wherein the length of the interface portion ranges between approximately 0.095 inch (0.241 cm) and 0.105 inch (0.267 cm) and the outer diameter of the interface portion ranges between approximately 0.3143 inch (0.7983 cm) and 0.3147 inch (0.7993 cm).

3. The hinge pin of claim 2, wherein the length of the interface portion is approximately 0.100 inch (0.254 cm) and the outer diameter of the interface portion is approximately 0.3145 inch (0.7988 cm).

4. The hinge pin of claim 1, wherein an outer diameter of the hinge pin from the first end to a beginning of the interference portion ranges between approximately 0.3115 inch (0.7912 cm) and 0.3125 inch (0.7938 cm).

5. The hinge pin of claim 4, wherein the outer diameter of the hinge pin from the first end to the beginning of the interference portion is approximately 0.3120 inch (0.7925 cm).

6. The hinge pin of claim 1, wherein the hinge pin is configured to be placed in a housing of a valve, and wherein a length of the hinge pin configured to be located within the housing of the valve ranges between approximately 3.70 inch (9.40 cm) and 3.71 inch (9.42 cm).

7. The hinge pin of claim 6, wherein the length of the hinge pin configured to be located within the housing of the valve is approximately 3.705 inch (9.411 cm).

8. The hinge pin of claim 1, further comprising a retention groove at or near the first end of the hinge pin.

9. A method for installing a hinge pin in a valve, the method comprising:
inserting a first end of the hinge pin into a first end of a housing of the valve;
sliding the hinge pin into the housing until an interference portion at or near a second end of the hinge pin contacts the housing; and
press fitting the interference portion of the hinge pin into the housing to create a clearance between an outer diameter of the hinge pin and a flapper coupling ranging between approximately 0.007 inch (0.018 cm) and 0.009 inch (0.023 cm).

10. The method of claim 9, wherein sliding the hinge pin into the housing comprises sliding the hinge pin through each flapper coupling.

11. The method of claim 9, further comprising:
creating a clearance between an outer diameter of the hinge pin and each flapper coupling ranging between approximately 0.007 inch (0.018 cm) and 0.009 inch (0.023 cm).

12. The method of claim 9, further comprising:
positioning the first end of the hinge pin to protrude out from a second end of the housing of the valve.

13. The method of claim 12, further comprising:
attaching a snap ring to a retention groove on the first end of the hinge pin.

14. The method of claim 9, further comprising:
cooling the hinge pin such that hinge pin shrinks and is insertable into the first end of the housing of the valve.

15. The method of claim 9, further comprising:
heating the housing of the valve such that the housing expands for inserting the hinge pin into the first end of the housing.
